(19) United States
(12) Patent Application Publication
(10) Pub. No.: US 2007/0196201 A1
(43) Pub. Date: Aug. 23, 2007

(54) Tailgate with storage means and built-in-ramp

(76) Inventor: Joe Kennedy, Lincoln, NE (US)

Correspondence Address: Joe Kennedy;IntoMetal, Inc., IntoMetal, Inc., 3340 North 33rd Street, Lincoln, NE, 68504, US

(21) Appl. No.: 11/358,620

(22) Filed: Feb. 21, 2006

(51) Int. Cl. B60P 1/00

(52) U.S. Cl. 414/537

(57) ABSTRACT

The invention provides two or more ramp members that are freely positionable along the rear of the cargo bed of a small truck to which the device is attached. The ramp members, when not deployed in use are folded onto a frame and are of an overall shape and size similar to conventional bumpers used for pick-up and other light trucks, extending across the rear of the vehicle. The invention also provides a tailgate assembly with storage means for a pickup truck vehicle. Twin tailgate doors are pivotally secured to the body of the pickup and are each movable about their respective and substantially vertical axes. Each tailgate door also forms a cargo storage apparatus, integrally. A locking mechanism may be provided. The cargo storage compartment may have various shelves and partitions therein; thermal insulation material may be added such that a compartment can serve as a food or beverage cooler; and lighting of various sorts may be added.

### BACKGROUND OF THE INVENTION

A. Field of the Invention

This invention, in part, relates generally to ramp structures for the loading of items into the bed of a truck, most often a pickup truck. In particular, the invention relates to an improved ramp structure for loading wheeled vehicles of various sorts. The invention, further, relates to a new and improved tailgate for such a pickup, to often be used in conjunction with the ramp structures, which tailgate comprises two sections, each opening about a vertical axis, and each containing storage means.

B. Related Art and Discussion

Several loading ramp devices have been developed for use in loading vehicles of different sorts into the load beds of pickups. Notable is U.S. Pat. No. 5,380,145 to Czaplewski which discloses such a loading ramp, having an adjustable ramp width. The Czaplewski device, at the same time, illustrates several of the shortcomings of the existing art. For instance, the known device is relatively heavy and cumbersome to deploy. It has portions which make deployment unnecessarily complicated. The Czaplewski device does not stow efficiently, has an unnecessarily limited ramp length and is somewhat unsightly. Finally, all of the known loading ramp mechanisms, and especially Czaplewski, have the effect of eliminating the pickup tailgate mechanism during use of the ramps and the interim period of time during which the loaded vehicle is transported.

As well, a number of pickup truck tailgate mechanisms have been developed to allow more efficient access to the load bed of a pickup. Some such devices have involved a vertical hinging of the door sections. For example, U.S. Pat. No. 5,876,086 to Lagrou, et al., discloses such vertically hinged door sections for application with the likes of pickup trucks and sport utility vehicles. U.S. Pat. No. 5,685,594, to Harper, discloses the use of tailgate section doors hinged on both the horizontal and vertical axes. U.S. Pat. No. 5,518,158, to Matlack, discloses a tailgate adapted with a toolbox assembly; while U.S. Pat. No. 6,502,885, to Gammon, et al., shows an adaptation for cargo storage. The known mechanisms, however, all suffer a number of similar shortcomings. In each instance, the known mechanism has limited practical utility, involves an unnecessarily large number of working parts, and is not shown to be economically capable of universal use, that is to say, such are not interchangeable from one brand of pickup truck to another.

### SUMMARY OF THE INVENTION

A main object of this invention is two-fold. First, a purpose is to provide an efficient loading ramp system for use with light trucks which, when not deployed for loading use, is easily stowed in the rear bumper of the truck. A second purpose of the present invention is to provide article storage compartments capable of serving as the tailgate of a light truck, such as a pickup, and, further, being compatibly used with the loading ramp system. The above and other objects, features, and advantages of the present invention will become more apparent from the following description when taken in conjunction with the accompanying drawings in which a preferred embodiment of the invention is shown by way of illustrative example.

### BRIEF DESCRIPTION OF THE DRAWINGS

FIG. 1 is a perspective view of the rear portion of a pickup truck body which incorporates a ramp system according to an embodiment of the present invention;

FIG. 2 is a similar perspective view of the subject ramp system, with the rear cover of the bumper area removed;

FIG. 3 is a similar perspective view of the subject ramp system with the ramps deployed;

FIG. 4 is a perspective view of a pickup truck body which incorporates a tailgate with storage means according to an embodiment of the present invention; and,

FIG. 5 presents a perspective view of a pickup truck body with the tailgate and storage means each in the opened position.

### DETAILED DESCRIPTION OF THE INVENTION

The first purpose of the present invention is now described more fully hereinafter, with reference to the accompanying drawings, in which a preferred embodiment of the invention is shown.

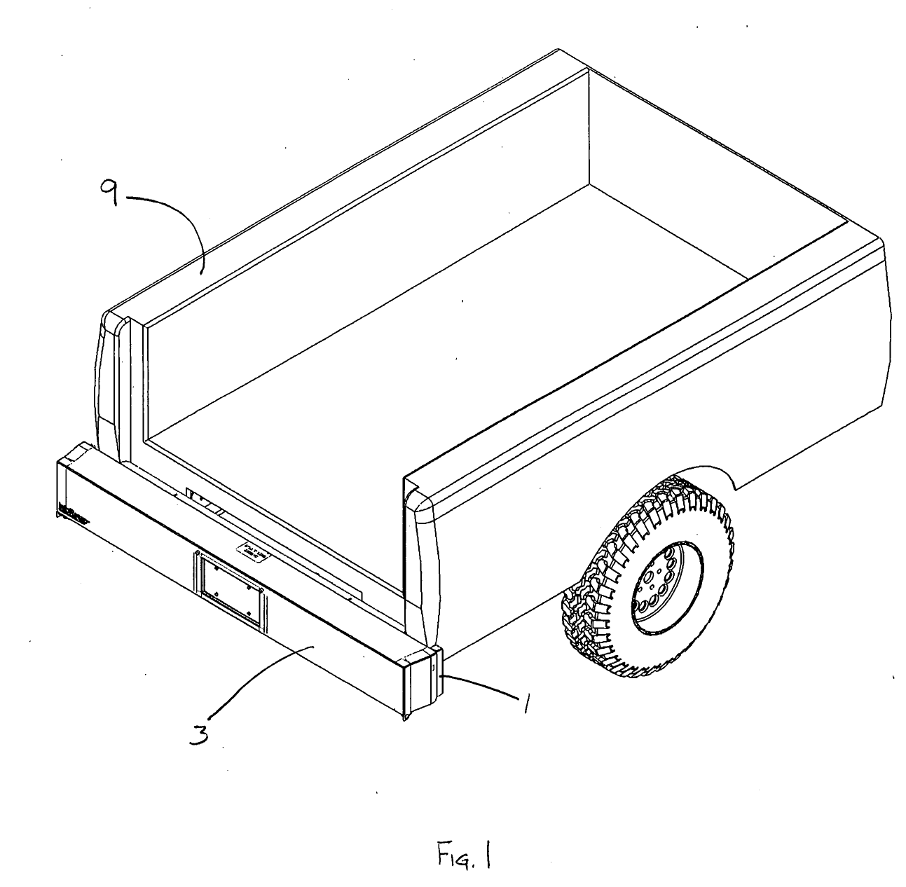

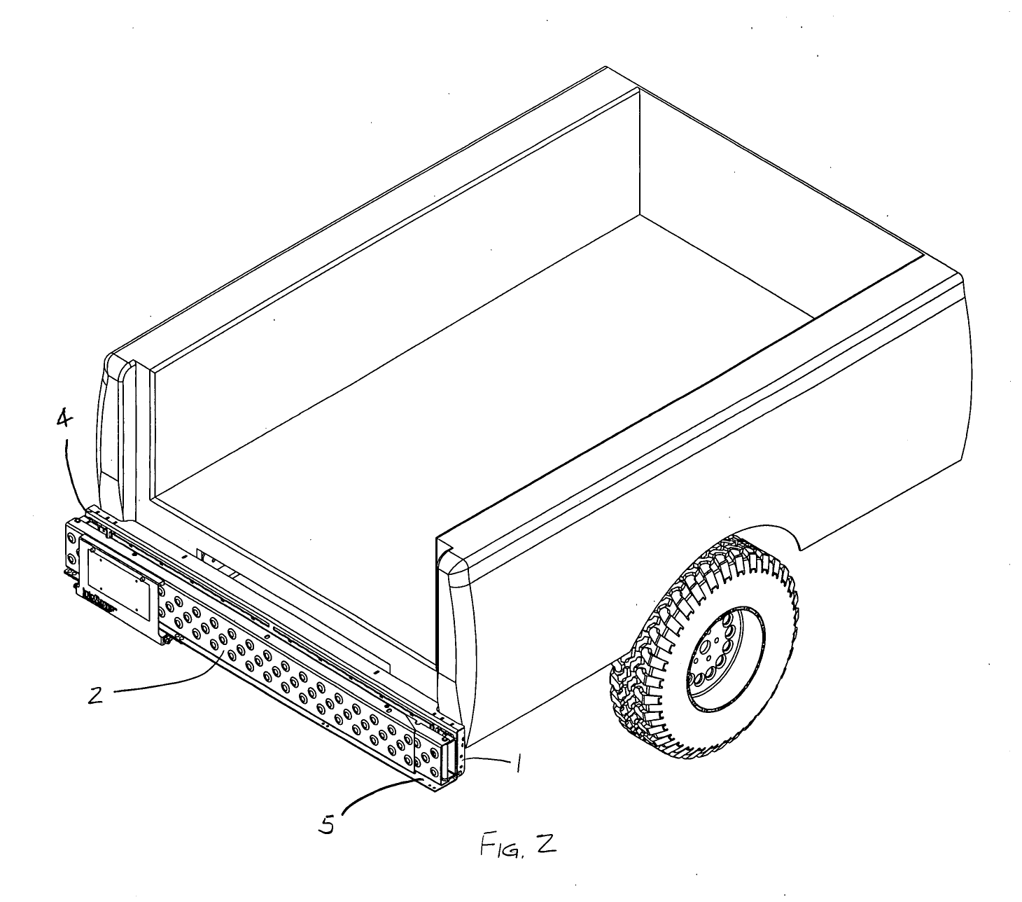

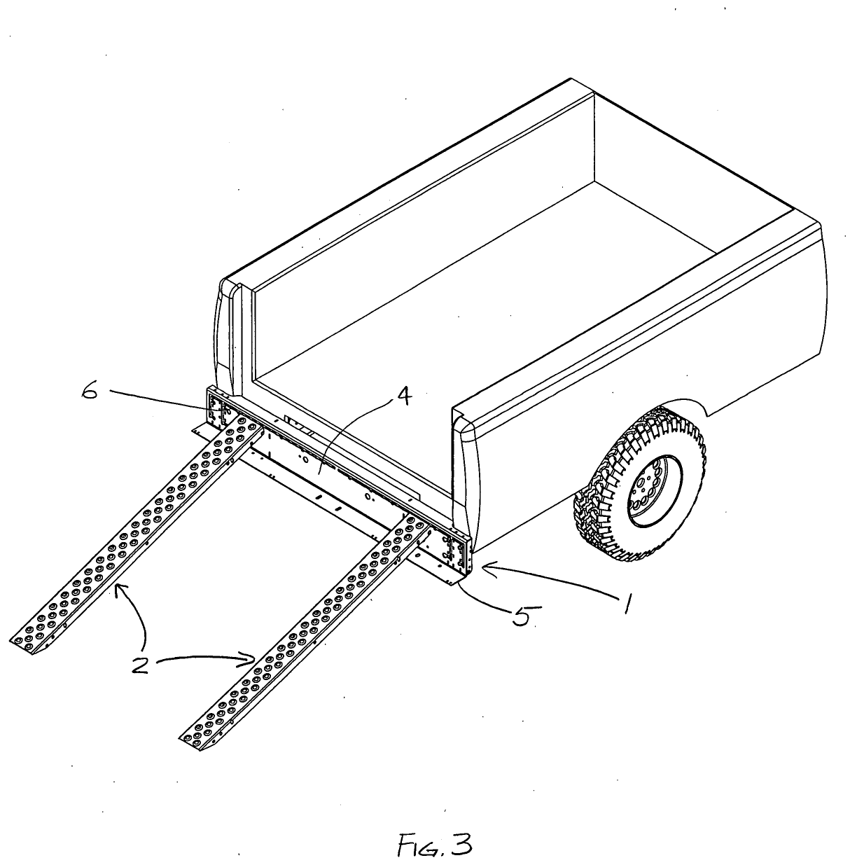

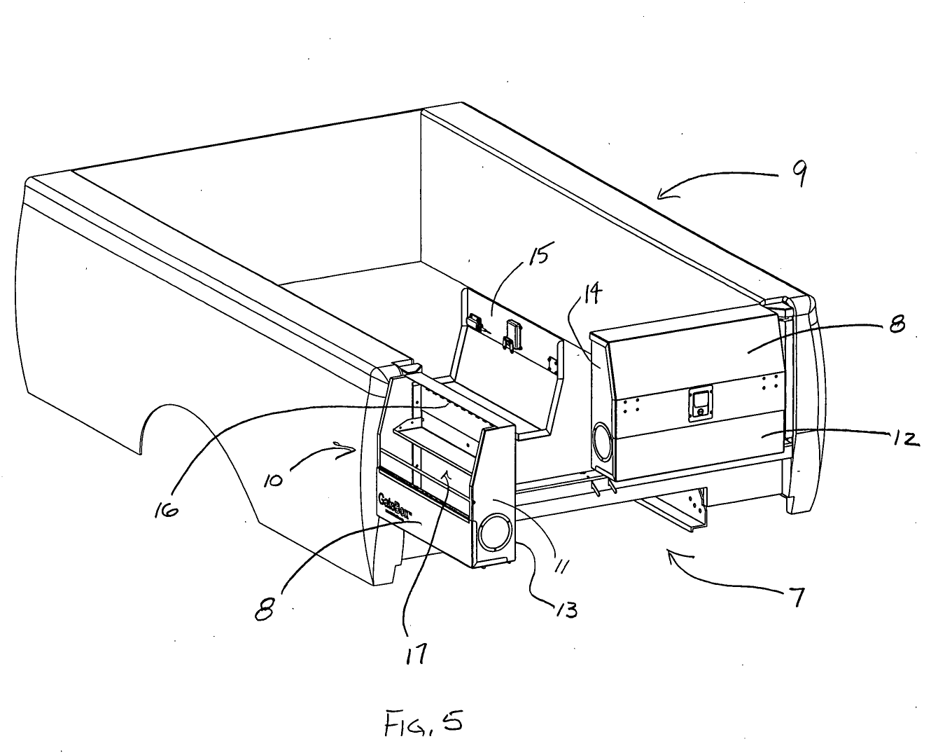

Referring now to FIG. 1, the first purpose of the present invention comprises two or more ramp members that are freely positionable along the rear of the cargo bed of a small truck to which the device is attached. The ramp members, when not deployed in use are folded onto a frame and are of an overall shape and size similar to conventional bumpers used for pick-up and other light trucks, extending across the rear of the vehicle. The ramp frame is mounted directly to the truck frame, generally in the same manner as the bumper which is removed to allow installation of the device. FIG. 1 illustrates the ramp frame 1, ramp members 2, and cover 3, all in the stowed position, and with the general appearance of a conventional rear bumper. Referring now to FIG. 2, the bumper cover 3, which is pivotally attached to the ramp frame 1 in normal use, and is, during deployment of the ramp members 2 merely rotated rearward and downward from the ramp frame 1, is shown in FIG. 2 to be removed, so as to disclose the enclosed mechanism of the ramp frame 1 and ramp members 2. The ramp frame 1 is as wide as the opening to the cargo bed and comprises a vertical mounting plate 4 that is as high as the ramp members 2 are wide and a horizontal base 5 at 90 degrees to the bottom of the mounting plate 4, the ramp frame 1 having an “L” shaped cross-section. The base plate 5 of the ramp frame 1 provides a base to which two ramp support rails 6 are fixed, at either end of the ramp frame 1. The support rails 6 are identical and are each formed of a continuous section. The outer ends of each support rail 6 are shaped with a 90 degree bend for a distance approximately as long as the ramp members 2 are wide, and each such rail end is directly and rigidly fastened to an end of the base plate 5 of the ramp frame 1. The support rails 6 thereby each form a elongated “U” shaped cross-section. Each support rail 6 is slidingly restrained within one end of a ramp member 2 each of which is accordingly allowed to slide along a support rail 6 at 90 degrees thereto. When the ramp member 2 is supported by the vertical, outer end of a support rail 6, the ramp member 2 assumes a horizontal position on edge with the surface of the ramp member 2 being vertical. When the ramp member is supported by a horizontal portion of the support rail 6, the surface of the ramp member 2 assumes a laterally horizontal aspect and may pivot as the outer end, that in this position extends rearward from the frame 1, may be raised or lowered as desired, as is evident in FIG. 3. The ramp members 2 are generally as long and wide as the mounting plate 4 of the ramp frame 1 with the exception that one ramp member 2 is narrower than the other by twice the gauge of the ramp member material to allow the nesting of the narrower ramp member in side the wider ramp member. Each ramp member 2 is formed of rectangular sheet of metal with each longitudinal edge turned 90 degrees to provide a side strip for additional strength and support when bearing a load. The surface of the ramp members 2 are generally flat and may be roughened or perforated to provide traction. Both side strips extend in the same direction and are nested when the ramp members 2 are not in use and are folded and are downward when the ramp members 2 are deployed for use. Each ramp member 2 is slidingly supported by a support rail 6 which is connected through holes in one end of the side strips at the end of the ramp member 2 that remains adjacent to the truck. When the device is not in use, the ramp members 2 are supported by the outer ends of the support rails 6, and are parallel to the ramp frame 1 extending laterally across the rear of the truck directly below the rear edge of the cargo bed. The narrower of the two ramp members 2 is pivoted on the support rail section into place before the wider ramp member to allow both to be folded flat against the mounting plate 4. The ramp members 2 may be secured in the folded position by means of a pin inserted into holes in the ramp member side strips and the base plate 5 of the ramp frame 1, which holes are only aligned when the ramp members 2 are properly folded. To deploy the ramp members 2, they are each folded out and away from the ramp frame 1, and then the ramp members 2 are moved along the support rails 6, to the horizontal position. Once the truck ends of the ramp members 2 are supported horizontally on the support rails 6, the other end may be placed on the ground, loading dock or other surface by vertically pivoting the ramp members 2 on the support rails 6. Since the device provides for loading directly into the load bed, the tailgate assembly, according to FIG. 5, is easily swung out of the way before loading. The lateral location of the ramp members 2 may be adjusted as desired or required for the particular loading task to be performed by sliding the ramp member 2 laterally along the support rails 6. For example the ramp members 2 may be placed in close proximity to each other to allow the device to be used as a walkway by a person or as a ramp for a vehicle with a single wheel or narrow wheel base. Conversely, the ramp members 2 may be adjusted away from each other as is needed to provide support for any width of any wheeled vehicle that may be accommodated by the cargo bed. The ramp members 2 are stored without limiting or reducing the load area and the device is of continuously adjustable width to be versatile and universally useful.

The purpose and intent of the present invention is to provide a new and improved mechanism for loading wheeled vehicles of various wheel bases into the rear load bed of a small truck.

A further purpose and intent of the present invention is to provide a new and improved loading mechanism of adjustable width and capable of use as an ordinary ramp.

Another and further purpose and intent of the present invention is to provide a loading mechanism with the aforesaid capacities and being compact and without limiting or reducing the available space in the truck bed.

The invention consists in the features of construction, combination of elements and arrangement of parts exemplified in the construction hereinafter described and the scope of the invention will be indicated in the appended claims.

The second purpose of the present invention now is described more fully hereinafter, with reference to the accompanying drawings, in which a preferred embodiment of the second purpose of the invention is shown.

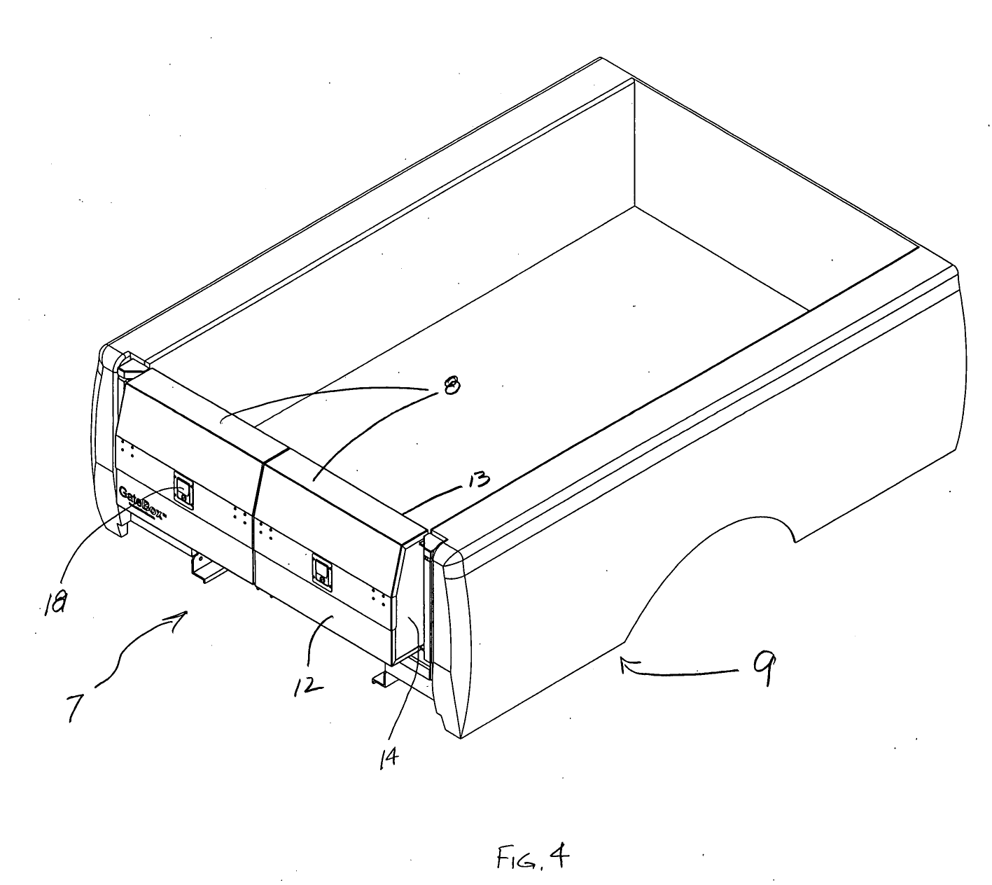

Referring now to FIG. 4, a tailgate assembly 7 with storage means for a pickup truck vehicle 9 according to the embodiment of the present invention is illustrated. Twin tailgate doors 8 are pivotally secured to the body 9 of the pickup and are each movable about their respective and substantially vertical axes between an open position and a closed position, as is understood by those skilled in the art. Each tailgate door 8 includes an interior portion 10 and an external portion 11. Each tailgate door 8 also forms a cargo storage apparatus, integrally. Each such tailgate door 8 comprises a housing having a front wall 12, a rear wall 13, opposed side walls 14, and an access door 15 pivotally secured to the rear wall 13 via a hinge means 16 which is movable between a closed position covering the opening 17 and an open position, according to FIG. 5, allowing access to the compartment 10 via the opening 17. A locking mechanism 18 may be provided according to embodiments of the present invention to maintain the access door 15 in the closed position and to prevent unauthorized access to the compartment 10. Together, the walls 12, 13, 14 and door 15 define a hollow interior portion that serves as a cargo storage compartment 10 (FIG. 5) for receiving articles therein.

The cargo storage compartment 10 (FIG. 5) according to the embodiments of the present invention may have various shelves and partitions therein, and is not limited to the illustrated embodiment. For instance, thermal insulation material may be added such that a compartment 10 can serve as a food or beverage cooler. Similarly, lighting of various sorts may be added. For example, one or more lights or reflectors may be added to illuminate the compartment 10.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention.

Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A loading ramp apparatus for attachment to the rear end of the load bed of a vehicle that has a load bed, means for attachment of a rear bumper, and a centerline, the apparatus comprising or consisting of:
a rectangular ramp member having a flat surface and being movable from a deployed position wherein one edge of the ramp member is in proximity to the rear edge of the vehicle load bed with said ramp member extending toward another surface, to a stowed position, wherein the ramp member is outside of the load bed and the flat surface of the ramp member is normal to the centerline of the vehicle, and
a rail member, generally shaped as an elongated “U”, in an inverted position secured in such position to support such ramp member in either the stowed or deployed positions, and
means for allowing lateral placement of the ramp member when said ramp member is deployed.

2. The apparatus of claim 1, wherein a plurality of ramp members are utilized.

3. The apparatus of claim 1, wherein the means for allowing placement of a ramp member consists of a means for securing one edge of a ramp member to the horizontal portion of the support rail.

4. The apparatus of claim 1, further consisting of a means for locking a ramp member in the stowed position.

5. A tailgate apparatus for a vehicle, comprising:
twin, opposed tailgate doors, pivotally secured to the vehicle body and movable about substantially vertical axes between open and closed positions,
each independent of the other, and wherein the tailgate doors each comprise an interior portion comprised of:
a housing, comprising a front wall, a taller rear wall, opposed side walls, and a hollow interior portion that serves as a compartment for storage of articles therein;
a door for access to said interior portion, hingedly coupled to the rear wall and movable between a closed position covering the opening and an open position allowing access to the interior by way of the opening.

6. The tailgate apparatus of claim 5 also comprising a means or mechanism for locking the access door in the closed position and to prevent unauthorized access thereto.

7. The tailgate apparatus of claim 5, further comprising a light disposed within the compartment that is designed to illuminate the interior of the compartment, or areas adjacent to it.

8. The tailgate apparatus of claim 5, wherein the compartments comprise receptacles for the storage of items therein.

9. The apparatus of claim 5, wherein the compartments are lined with thermal insulation in such fashion as to allow the compartments to serve as coolers for food or drink.
